(19) United States
(12) Patent Application Publication
(10) Pub. No.: US 2021/0164675 A1
(43) Pub. Date: Jun. 3, 2021

(54) INTELLIGENT HUMIDIFICATION SYSTEM IN WHICH REMOTE CONTROLLER WITH BUILT-IN SENSOR AND HUMIDIFIER ARE LINKED

(71) Applicant: MIRO CO., LTD., Incheon (KR)

(72) Inventors: Dong Jin SEO, Incheon (KR); Yong Ju OH, Incheon (KR); Min Seok KIM, Incheon (KR)

(21) Appl. No.: 17/261,459

(22) PCT Filed: Apr. 23, 2019
(86) PCT No.: PCT/KR2019/004867

§ 371 Date: Jan. 19, 2021

(30) Foreign Application Priority Data
Jul. 17, 2018 (KR) 10-2018-0083181
Apr. 22, 2019 (KR) 10-2019-0046931

(51) Int. Cl. F24F 11/00; F24F 11/52

(52) U.S. Cl. CPC F24F 11/0008; F24F 11/64; F24F 11/52

(57) ABSTRACT

An intelligent humidification system according to the present invention in which a remote controller with a built-in sensor and a humidifier are linked, includes: a humidifier; a remote controller which is attached to/detached from a holder equipped in the humidifier and measures atmospheric environment information of a located space using a built-in sensor; and a humidification controller which is connected to the humidifier through a wire and is connected to the remote controller in a wireless manner to control the humidifier according to the atmospheric environment information measured by the remote controller, so that a humidity of a place where a user carrying the remote controller is located is measured and the humidifier is operated by taking into account the measured humidity value, thereby achieving user-oriented humidification.

### TECHNICAL FIELD

The present invention relates to an intelligent humidification system in which a remote controller having a built-in sensor and a humidifier are linked, and more particularly, to an intelligent humidification system in which a remote controller having a built-in sensor and a humidifier are linked which includes a humidity sensor in a remote controller which controls a humidifier to measure a humidity of a place where a user with the remote controller is located and operate the humidifier by taking into account the measured humidity value to achieve user-oriented humidification.

### DESCRIPTION OF THE RELATED ART

Generally, a humidifier is a device which makes humidification water into steam and injects the steam into the air in order to keep the room at a humidity suitable for the human body.

The humidifier is mainly classified into a humidifier using a heater and an ultrasonic type humidifier. The humidifier using a heater heats humidification water using an electric heater at a predetermined temperature to generate moisture and ejects the moisture using an air blowing unit to the room to perform humidification.

In contrast, the ultrasonic type humidifier uses a vibrator to convert the humidification water into moisture to perform the humidification. The humidifier using a heater has an advantage in that the humidification water in a water tank is sterilized, but also has a disadvantage in that electric charges due to the heating are increased. Therefore, in recent years, as a small size humidifier, mainly ultrasonic type humidifiers are adopted.

The ultrasonic type humidifier has a structure in which a waterspout is disposed below a water tank which stores humidification water and a vibrator which converts the humidification water introduced in the waterspout into moisture is installed and the moisture is discharged to the outside by an air blower.

However, in many cases, a humidity around the humidifier may be different from a humidity in a space where a user actually lives. Therefore, there is a problem in that humidity and temperature sensors built in the humidifier have less accuracy as compared with an actual usage environment.

That is, a humidifier of the related art includes a built-in humidity sensor which measures a humidity to be operated in accordance with a humidity in a surrounding space but cannot properly reflect the humidity of the space where the user is actually located.

### DISCLOSURE

### Technical Problem

An object of the present invention is to provide an intelligent humidification system in which a remote controller with a built-in sensor and a humidifier are linked which includes a humidity sensor in a remote controller which controls a humidifier to measure a humidity of a place where a user with the remote controller is located and when the measured humidity value is transmitted to a controller in a wireless manner, operate the humidifier which is connected to the controller through a wire by taking into account the measured humidity value to achieve user-oriented humidification.

### Technical Solution

In order to achieve the above-described object, an intelligent humidification system according to the present invention in which a remote controller with a built-in sensor and a humidifier are linked includes a humidifier; a remote controller which is attached to/detached from a holder equipped in the humidifier and measures atmospheric environment information of a located space using a built-in sensor; and a humidification controller which is connected to the humidifier through a wire and is connected to the remote controller in a wireless manner to control the humidifier according to the atmospheric environment information measured by the remote controller.

In order to achieve the above-described object, a remote controller of an intelligent humidification system according to the present invention in which a remote controller with a built-in sensor and a humidifier are linked includes a communication unit for short range wireless communication with the humidification controller; a sensor module which measures atmospheric environment information of a space where the remote controller is located; a display unit which displays the atmospheric environment information measured by the sensor module; a manual control signal input unit which allows a user to manually control an output of the humidifier according to the atmospheric environment information displayed on the display unit; and a mode switching unit which switches a mode of the humidifier to an automatic mode or a manual mode.

In order to achieve the above-described object, a sensor module of an intelligent humidification system according to the present invention in which a remote controller with a built-in sensor and a humidifier are linked includes a humidity sensor, a temperature sensor, a gas sensor, and a dust sensor which measure humidity, temperature, a toxic gas concentration, and a dust concentration corresponding to the atmospheric environment information of a space where the remote controller is located, respectively.

In order to achieve the above-described object, a humidification controller of an intelligent humidification system according to the present invention in which a remote controller with a built-in sensor and a humidifier are linked includes a communication module which is configured by a short range communication unit for short range wireless communication with a communication unit of the remote controller and an external communication unit for long range wireless communication with an external device; a reference DB which stores output information of the humidifier according to a range of the humidity, the temperature, the toxic gas concentration and the dust concentration; and a controller which receives the atmospheric environment information measured by the sensor module to compare the atmospheric environment information with a reference value stored in the reference DB to control the humidifier with corresponding output information.

In order to achieve the above-described object, a controller of an intelligent humidification system according to the present invention in which a remote controller with a built-in sensor and a humidifier are linked increases an output of the humidifier when the measured humidity and temperature are in the range which needs to increase an output to be higher than a current output of the humidifier, decreases the output of the humidifier when the humidity and the temperature are in the range which needs to decrease an output to be lower than the current output, and maintains the current output as it is when the humidity and the temperature are in the same range as the current output.

In order to achieve the above-described object, a controller of an intelligent humidification system according to the present invention in which a remote controller with a built-in sensor and a humidifier are linked, when the measured toxic gas concentration and dust concentration are in the range needed to be higher than the current output of the humidifier, primarily outputs a warning message to induce ventilation and then controls the output of the humidifier.

In order to achieve the above-described object, a communication module of an intelligent humidification system according to the present invention in which a remote controller with a built-in sensor and a humidifier are linked is a detachable/attachable type to be changeable according to the change of a communication method of the short range communication module and the external communication module.

In order to achieve the above-described object, at least one of a humidity sensor, a temperature sensor, a gas sensor, and a dust sensor is attachable to the communication module of an intelligent humidification system according to the present invention in which a remote controller with a built-in sensor and a humidifier are linked.

In order to achieve the above-described object, an intelligent humidification system according to the present invention in which a remote controller with a built-in sensor and a humidifier are linked further includes a server connected to perform long range wireless communication with an external communication unit of the humidification controller; a smart phone which is connected to the server to control the humidifier; and an AI speaker which is connected to the server to control the humidifier using a voice.

In order to achieve the above-described object, a server of an intelligent humidification system according to the present invention in which a remote controller with a built-in sensor and a humidifier are linked includes an interface unit; a server controller which receives a humidifier control operation of a user from a gas controller through the interface unit and learns the humidifier control operation to calculate a control pattern; an APP DB which stores and manages an APP which controls the humidifier; and a big data DB which stores and manages control pattern information calculated by the server controller.

In order to achieve the above-described object, a server controller of an intelligent humidification system according to the present invention in which a remote controller with a built-in sensor and a humidifier are linked controls the humidifier with a manual control signal which manually controls the humidifier from the outside through the smart phone with the APP installed therein by the user and with an automatic control signal which reflects the control pattern to control the humidifier by selecting an automatic mode.

In order to achieve the above-described object, a server controller of an intelligent humidification system according to the present invention in which a remote controller with a built-in sensor and a humidifier are linked receives user position information from the smart phone to calculate a time taken to get home from the current position and reflects the current home humidity, the time taken to get home, and the control pattern, and then determine an output of the humidifier to transmit the output to the humidification controller.

In order to achieve the above-described object, an AI speaker of an intelligent humidification system according to the present invention in which a remote controller with a built-in sensor and a humidifier are linked, after receiving a voice signal of the user, converts the voice signal into a control signal and transmits the control signal to the connected server to control the humidifier with a voice.

### Advantageous Effects

According to the present invention, an intelligent humidification system in which a remote controller with a built-in sensor and a humidifier are linked measures a humidity of a place where a user with the remote controller is located and operates the humidifier by taking into account the measured humidity value to achieve user-oriented humidification.

### DESCRIPTION OF DRAWINGS

FIG. 1 is a block diagram of an intelligent humidification system according to the present invention in which a remote controller including a built-in sensor and a humidifier are linked.

FIG. 2 is a detailed block diagram of a remote controller of an intelligent humidification system according to the present invention in which a remote controller including a built-in sensor and a humidifier are linked.

FIG. 3 is a block diagram of a humidification controller of an intelligent humidification system according to the present invention in which a remote controller including a built-in sensor and a humidifier are linked.

FIG. 4 is a block diagram of another embodiment of an intelligent humidification system according to the present invention in which a remote controller including a built-in sensor and a humidifier are linked.

FIG. 5 is a detailed block diagram of a server of an intelligent humidification system according to the present invention in which a remote controller including a built-in sensor and a humidifier are linked.

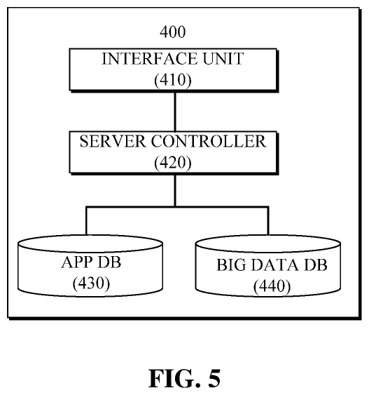

### BEST MODE

Hereinafter, exemplary embodiments according to the present invention will be described in detail with reference to accompanying drawings.

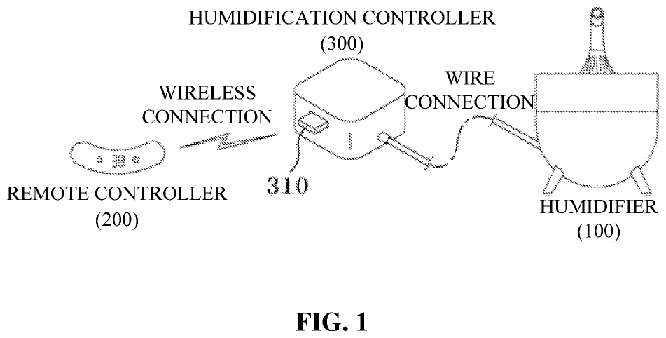

An intelligent humidification system according to the present invention in which a remote controller including a built-in sensor and a humidifier are linked, as illustrated in FIG. 1, includes a humidifier 100, a remote controller 200, and a humidification controller 300.

The humidifier 100 is connected to the humidification controller 300 to perform wired communication to be operated according to a signal transmitted from the humidification controller 300.

For reference, the humidifier 100 is a device that artificially maintains a desired humidity when appropriate humidity is required due to a dry season such as winter or other factors and includes an ultrasonic type humidifier which converts water into particles using electricity, a heating type which makes moisture to spray the moisture to the room, a hybrid type in which a ultrasonic type and a heating type are combined, a centrifugal spraying type which blows the sucked water by centrifugal force to hit the screen, breaks up the water into tiny particles, and sends the particles out, and a filter-evaporative type which allows air to pass through a wet filter to evaporate water and make moisture.

The remote controller 200 is connected to the humidification controller 300 in a wireless manner to transmit a control signal for controlling the humidifier 100 by means of short range wireless communication.

The short range wireless communication may include at least one of wireless fidelity (WiFi), Bluetooth, near field communication (NFC), and global navigation satellite system (GNSS).

The humidifier 100 includes a holder so that the remote controller 200 may be inserted in or extracted from the holder.

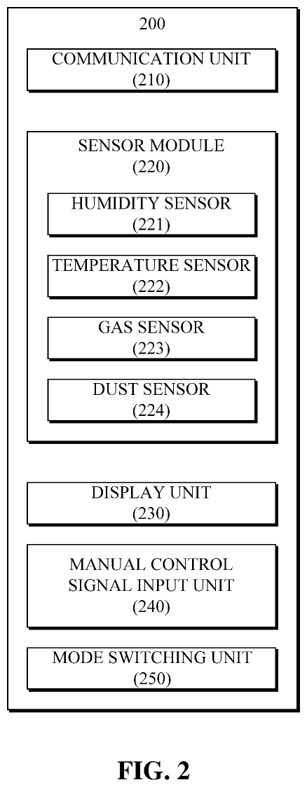

As illustrated in FIG. 2, the remote controller 200 includes a communication unit 210, a sensor module 220, a display unit 230, a manual control signal input unit 240, and a mode switching unit 250.

The communication unit 210 provides an interface for short range wireless communication with the humidification controller 300 as described above.

The sensor module 200 includes sensors which measure atmospheric environment information, that is, includes a humidity sensor 221, a temperature sensor 222, a gas sensor 223, and a dust sensor 224. The humidity sensor 221 measures a humidity of a space where a remote controller 200 is located or an activity space of a user carrying the remote controller 200, the temperature sensor 222 measures a temperature, the gas sensor 223 measures a concentration of gas in the air, and the dust sensor 224 measures a concentration of dusts in the air.

The display unit 230 displays a measurement value of any one or more of the humidity, the temperature, gas, and dust measured by the humidity sensor 221, the temperature sensor 222, the gas sensor 223, and the dust sensor 224 with a numerical value or different colored light.

The manual control signal input unit 240 is a button or a touch type input unit formed on the remote controller 220 and allows the user to make a judgement and directly control the operation of the humidifier according to the measurement value which is measured by the sensor module 220 to be displayed on the display unit 230.

That is, when the humidity measured by the humidity sensor 221 is low, the user manipulates the manual control signal input unit 240 to increase the humidity by increasing an output of the humidifier 100 to be higher than a current state and when the humidity is high, to lower the humidity by lowering the output of the humidifier 100 to be lower than the current state.

The mode switching unit 250 is provided on the remote controller 200 as a button or a touch type to be switched to an automatic mode or a manual mode according to the manipulation. When the mode switching unit is switched to the manual mode, the user may manually control the humidifier 100 by means of the manual control signal input unit 240 as described above.

However, when the mode switching unit is switched to the automatic mode, the remote controller 200 transmits an automatic control signal which automatically controls the humidifier 100 according to the measurement value of the humidity, the temperature, gas and dust measured by the sensor module 220 to the humidification controller 300 to automatically control the humidifier 100.

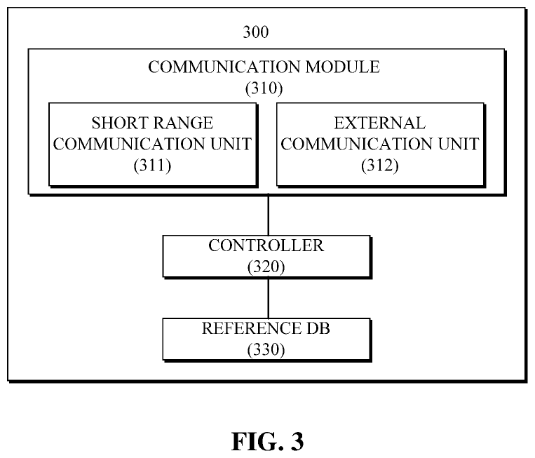

The humidification controller 300, as illustrated in FIG. 3, includes a communication module 310 including a short range communication unit 311 and an external communication unit 312, a controller 320, and a reference DB 330.

The short range communication unit 311 provides an interface for short range wireless communication with the communication unit 210 of the remote controller 200 described above.

The controller 320 receives a manual control signal or an automatic control signal which is received by the short range communication unit 311 from the remote controller 200 to control the humidifier 100 which is connected by wired communication.

The wired communication may include at least one of universal serial bus (USB), high definition multimedia interface (HDMI), recommended standard 232 (RS-232), and plain old telephone service (POTS).

In the meantime, when the mode is switched to the automatic mode, the humidification controller 300 receives the measurement value of the humidity, the temperature, the gas, and the dust from the remote controller 200 to control a spraying amount of the humidifier by automatically increasing or decreasing an output of the humidifier 100 according to the range of the measurement value stored in the reference DB 330.

To be more specific, in the reference DB 330, output information indicating whether to increase or decrease an output of the humidifier 100 according to the range of the measurement value of the humidity, the temperature, the gas, and the dust is stored.

That is, the humidifier output information according to the range of the measurement value of the humidity, the temperature, the gas, and the dust stored in the reference DB 330 is as represented in the following Table 1.

TABLE 1

| Humidifier output | High | Intermediate | Low |
|---|---|---|---|
| Humidity | 10% to 30% | 30% to 70% | 70% to 100% |
| Temperature | Optimal temperature | Optimal temperature | Optimal temperature |
| | or lower | (24° C.) | or higher |
| Gas | NO₂ contamination | NO₂ contamination | NO₂ contamination |
| | 25% or lower | 25% to 39% | 25% or lower |
| | CO contamination | CO contamination | CO contamination |
| | 21% or lower | 21% or lower | 21% or lower |
| Dust | Dust concentration | Dust concentration | Dust concentration |
| | (80 μg/m³ or higher) | (30 μg/m³~80 μg/m³) | (30 μg/m³ or higher) |

For reference, the numerical range in Table 1 for the humidity, the temperature, the gas, and the dust which determines the output of the humidifier 100 to be high, intermediate, and low corresponds to an arbitrary value according to an embodiment and may be changed as many as necessary. When the humidity among the measurement values of the humidity, the temperature, the gas, and the dust which are transmitted together with the automatic control signal according to information stored in the reference DB 330 is 10% to 30% in the air, the controller 320 determines that the humidity is a numerical value to increase the output of the humidifier 100 according to the information stored as a database as represented in Table 1 in the reference DB 330 to automatically increase the output of the humidifier. In contrast, when the humidity is 70% to 100% in the air, the controller 320 determines that the humidity is a numerical value to decrease the output of the humidifier 100 according to the information stored as a database in the reference DB 330 to automatically decrease the output of the humidifier 100.

In the meantime, when the temperature measurement value of the space measured by the temperature sensor 222 is received and the temperature is high, the controller 320 of the humidification controller 300 controls the humidifier 100 to increase a spraying amount to lower the temperature.

Further, the controller 320 of the humidification controller 300 receives the gas measurement value of the space measured by the gas sensor 232, and when the gas concentration is equal to or higher than a reference value stored in the reference DB 330, the controller 320 of the humidification controller 300 primarily sends a warning message to the display unit 230 of the remote controller 200 to perform ventilation and when the gas concentration is still equal to or higher than the reference value, increases an output of the humidifier 100 to sink the gas to the bottom by the sprayed water to lower the gas concentration.

Similarly, the controller 320 of the humidification controller 300 receives the measurement value of dusts including fine dusts of the space measured by the dust sensor 224 and when the dust is equal to or higher than the reference value stored in the reference DB 330, increases the output of the humidifier 100 to sink the dust to the bottom by the sprayed water to lower the concentration of the dust.

The controller 320 receives the measurement value of the dust measured by the dust sensor 224 and then when the dust measurement value is equal to or higher than the reference value stored in the reference DB 330, desirably, primarily sends the warning message to the display unit 230 to induce the ventilation.

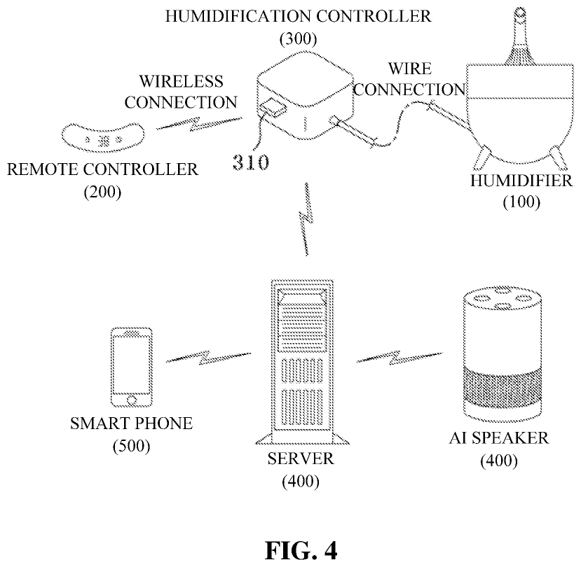

The external communication unit 312 of FIG. 3 allows the humidification controller 300 to perform long range wireless communication with an external server 400 as illustrated in FIG. 4 to control the humidifier 100 by an external device connected to the server 400.

The long range wireless communication may use at least one of long-term evolution (LTE), LTE advance (LTE-A), code division multiple access (CDMA), wideband CDMA (WCDMA), universal mobile telecommunication system (UMTS), wireless broadband (WiBro), and global system for mobile communications (GSM).

In this case, the communication module 310, that is, the short range communication unit 311 and the external communication unit 312 are attachable to/detachable from the humidification controller 300 so that when the communication method with the remote controller 200 which performs wireless communication or the server 400 to be described below is changed, desirably, the communication method may be easily changed.

That is, during Bluetooth communication and WiFi communication of the short range communication unit 311 and the external communication unit 312 with the remote controller 200 and the server 400, respectively, when the communication method is changed to NFC and LTE, the short range communication unit 311 and the external communication unit 312 are changed to communication modules which support the NFC and LTE to easily change the communication method.

Further, in this case, separately from the humidity sensor 221, the temperature sensor 222, the gas sensor 223, and the dust sensor 224 of the remote controller 200, desirably, the humidity sensor 221, the temperature sensor 222, the gas sensor 223, and the dust sensor 224 may be attachable to/detachable from the short range communication unit 311 and the external communication unit 312.

As described above, the communication module 310 is easily replaceable according to the communication method and any one of the humidity sensor 221, the temperature sensor 222, the gas sensor 223, and the dust sensor 224 can be attached thereto so that scalability is excellent. The intelligent humidification system according to the present invention in which a remote controller including a built-in sensor and a humidifier are linked, as illustrated in FIG. 4, further includes a server 400 and a smart phone 500 and an AI speaker 600 which are smart devices connected to the server 400.

For reference, the smart phone 500 and the AI speaker 600 may be connected to the server 400, but may be directly connected to the gas controller 300.

The smart device is not limited to the smart phone 500 and the AI speaker 600, but may be any one of a tablet personal computer (tablet PC), a mobile phone, an e-book reader, a laptop personal computer (laptop PC), a netbook computer, a workstation, a personal digital assistant (PDA), a portable multimedia player (PMP), and a wearable device.

The server 400 includes an interface unit 410, a server controller 420, an APP DB 430, and a big data DB 440.

The server 400 is connected to the gas controller 300 by means of the interface unit 410 to store and manage the measurement value of the humidity, the temperature, the gas, and the dust measured by the sensor module 220 of the remote controller 200.

In particular, the server 400 learns the measurement values of the humidity, the temperature, the gas, and the dust and how the user controls the humidifier 100 by manual control by means of the manual control signal input unit 240 at each time, and accumulates this as big data and store and manage the data in the big data DB 440.

For example, when it is assumed that the output of the humidifier 100 is set to high, intermediate, and low, if the user manually controls the output of the humidifier 100 to be “high” when the humidity value measured by the humidity sensor 221 is 10% to 30%, to be “intermediate” when the humidity value is 30% to 70%, and to be “low” when the humidity value is 70% to 100%, the server controller 420 of the server 400 learns the user's control pattern of the humidifier 100 to store and manage the control pattern.

Even though the humidity has been described above as an example, the server 400 also learns the user's control operation for the humidifier 100 according to the measurement value of the temperature, the gas, and the dust to calculate a control pattern and then store and manage the control pattern.

In the meantime, the APP DB 430 of the server 400 stores and manages the APP which controls the humidifier 100 in the smart device and updates a control function with update information input by an APP manager and provides the APP to the smart device of the user of the humidifier 100 accessed through the interface unit 410.

To be more specific, the humidifier user downloads and installs the APP from the server 400 using the smart phone 500 and then operates the installed APP to control the humidifier 100.

In particular, the user executes the APP of the smart phone 500 in the outside to access the server 400 and receives humidity, temperature, gas, and dust measurement information measured by the remote controller 200 and may manually control the humidifier 100.

In this case, when the user selects the automatic control of the humidifier 100 from the APP of the smart phone 500, the server 400 automatically controls the humidifier 100 according to the learned user's control pattern.

That is, when the humidity of the space currently measured by the remote controller 200 is 30% to 70%, the server 400 transmits a command to the humidification controller 300 to maintain an output of the humidifier 100 to be “intermediate” as learned.

When the humidifier 100 is controlled by the smart phone 500, user's position information by a position checking module installed in the smart phone 500 is also transmitted to the server 400 to allow the server controller 420 of the server 400 to calculate a time taken to get home from the current location and determines an output of the humidifier 100 to maintain an optimal humidity when the user arrives at home by taking into account a current room humidity and a time taken to get home, and if necessary, the control pattern and transmits the output to the humidification controller 300.

The position checking module may include at least one of global positioning system (GNSS), global positioning system (GPS), global navigation satellite system (Glonass), Beidou (beidou navigation satellite system), Galileo and the European global satellite-based navigation system, depending on the usage area, bandwidth, etc.

In the meantime, the AI speaker 600 connected to the server 400 may be installed in the smart phone 500 or disposed in a vehicle or at home to convert an input voice into a control signal to control the humidifier 100.

That is, when the AI speaker 600 converts the voice into the control signal to transmit the control signal to the server 400, the server 400 transmits the control signal to the humidification controller 300 again to operate the humidifier 100 as spoken by the user.

Although the exemplary embodiment of the present invention has been described above, the present invention is modified in various forms. It is further understood that those skilled in the art may carry out various variations and modification without departing from the Claim of the present invention.

1. An intelligent humidification system in which a remote controller with a built-in sensor and a humidifier are linked, the intelligent humidification system comprising:
a humidifier;
a remote controller which is attached to/detached from a holder equipped in the humidifier and measures atmospheric environment information of a located space; and
a humidification controller which is connected to the humidifier through a wire and is connected to the remote controller in a wireless manner to control the humidifier according to the atmospheric environment information measured by the remote controller.

2. The intelligent humidification system of claim 1, wherein the remote controller includes:
a communication unit for short range wireless communication with the humidification controller;
a sensor module which measures the atmospheric environment information of the located space where the remote controller is located;
a display unit which displays the atmospheric environment information measured by the sensor module;
a manual control signal input unit which allows a user to manually control an output of the humidifier according to the atmospheric environment information displayed on the display unit; and
a mode switching unit which switches a mode of the humidifier to an automatic mode or a manual mode.

3. The intelligent humidification system of claim 2, wherein the sensor module includes:
a humidity sensor, a temperature sensor, a gas sensor, and a dust sensor which measure humidity, temperature, a toxic gas concentration, and a dust concentration corresponding to the atmospheric environment information of the located space, respectively.

4. The intelligent humidification system of claim 3, wherein the humidification controller includes:
a communication module includes a short range communication unit for short range wireless communication with the communication unit and an external communication unit for long range wireless communication with an external device;
a reference DB which stores output information of the humidifier according to a range of the humidity, the temperature, the toxic gas concentration and the dust concentration; and
a controller which receives the atmospheric environment information measured by the sensor module to compare the atmospheric environment information with a reference value stored in the reference DB to control the humidifier with corresponding output information.

5. The intelligent humidification system of claim 4, wherein the controller increases an output of the humidifier when the measured humidity and temperature are in the range which needs to increase an output to be higher than a current output of the humidifier, decreases the output of the humidifier when the humidity and the temperature are in the range which needs to decrease an output to be lower than the current output, and maintains the current output as it is when the humidity and the temperature are in the same range as the current output.

6. The intelligent humidification system of claim 5, wherein when the measured toxic gas concentration and dust concentration are in the range which needs to increase an output to be higher than the current output of the humidifier, the controller primarily outputs a warning message to induce ventilation and then controls the output of the humidifier.

7. The intelligent humidification system of claim 4, wherein the communication module is a detachable/attachable type to be changeable according to the change of a communication method of the short range communication unit and the external communication unit.

8. The intelligent humidification system of claim 7, wherein at least one of a humidity sensor, a temperature sensor, a gas sensor, and a dust sensor is attachable to the communication module.

9. The intelligent humidification system of claim 4, further comprising:
a server connected to perform long range wireless communication with the external communication unit;
a smart phone which is connected to the server to control the humidifier; and
an AI speaker which is connected to the server to control the humidifier using a voice.

10. The intelligent humidification system of claim 9, wherein the server includes:
an interface unit;
a server controller which receives a humidifier control operation of a user from a gas controller through the interface unit and learns the humidifier control operation to calculate a control pattern;
an APP DB which stores and manages an APP which controls the humidifier; and
a big data DB which stores and manages control pattern information calculated by the server controller.

11. The intelligent humidification system of claim 10, wherein the server controller controls the humidifier with a manual control signal which manually controls the humidifier from the outside through the smart phone with the APP installed therein by the user and with an automatic control signal which reflects the control pattern to control the humidifier by selecting an automatic mode.

12. The intelligent humidification system of claim 10, wherein the server controller receives user position information from the smart phone to calculate a time taken to get home from the current position and reflects the current home humidity, the time taken to get home, and the control pattern, and then determines an output of the humidifier to transmit the output to the humidification controller.

13. The intelligent humidification system of claim 10, wherein after receiving a voice signal of the user, the AI speaker converts the voice signal into a control signal and transmits the control signal to the connected server to control the humidifier with a voice.
